(19) United States
(12) Patent Application Publication
(10) Pub. No.: US 2011/0249093 A1
(43) Pub. Date: Oct. 13, 2011

(54) THREE-DIMENSIONAL VIDEO IMAGING DEVICE

(75) Inventors: YU-CHOU YEH, TAOYUAN COUNTY (TW); HSIAO-SHUN JAN, TAOYUAN COUNTY (TW)

(73) Assignee: J TOUCH CORPORATION, TAOYUAN COUNTY (TW)

(21) Appl. No.: 12/836,821

(22) Filed: Jul. 15, 2010

(30) Foreign Application Priority Data
Apr. 7, 2010 (TW) 099110704

(51) Int. Cl. H04N 13/02

(52) U.S. Cl. 348/46; 348/E13.074

(57) ABSTRACT

A three-dimensional (3D) video imaging device includes a liquid crystal layer, a color filter plate, a lens array, light shielding elements and an optical sheet, and the lens array includes lens elements installed onto a surface of the color filter plate, and the light shielding elements are installed onto a surface of the color filter plate or lens element or formed directly in the color filter plate, and the light shielding elements are arranged with an interval apart from each other and corresponding to the intervals among the lens elements, and a combination of the liquid crystal layer, color filter plate and optical sheet constitutes an LCD panel structure for installing the lens array and the light shielding elements into the LCD panel directly to reduce the thickness and simplify the manufacturing process, while preventing stray lights, improving the clarity of 3D images, and maintaining a high-brightness display effect.

### CROSS-REFERENCE TO RELATED APPLICATIONS

This non-provisional application claims priority under 35 U.S.C. §119(a) on Patent Application No(s). 099110704 filed in Taiwan, R.O.C. on Apr. 7, 2010, the entire contents of which are hereby incorporated by reference.

### BACKGROUND OF THE INVENTION

1. Field of the Invention

The present invention generally relates to a video imaging field, and more particularly to a three-dimensional (3D) video imaging device capable of simplifying the manufacturing procedure, reducing the overall thickness of the device, and improving the clarity of a 3D image.

2. Description of the Related Art

In present existing 3D image display technologies, binocular disparity is generally used for receiving different images by a viewer's left and right eyes, such that the viewer's brain can combine the images into a 3D image. Basically, the 3D display technologies are mainly divided into two types, respectively: a stereoscopic display and an autostereoscopic display, wherein the stereoscopic display includes a polarization type and a time division type, and the autostereoscopic display technology is mainly divided into a lenticular lens and a barrier according to a display structure. The aforementioned two types of display structures have both advantages and disadvantages, wherein the lenticular lens is composed of many slender convex lens arranged continuously in an axial direction, and the principle of light refraction is used for producing different views to the viewer's left and right eyes. Compared with the barrier type, a light refraction is used to achieve the effect of splitting light in order to minimize light loss and maintain high brightness. If there is a manufacturing error of the lenticular lens, stray lights will be produced due to an uneven lens surface, and a portion of the 3D image may become blurred, and thus the overall 3D image display effect is affected adversely. On the other hand, the barrier type uses a row of barriers for restricting lights of certain angles from projecting, and only allowing viewing images of certain angles to be transmitted to the viewer's left and right eyes to produce a 3D image. Compared with the lenticular lens, the barrier type provides a sharper image for a single eye, but its structural characteristic will lower the overall image brightness and resolution.

In addition, the 3D video display method of the aforementioned type includes a lenticular lens and a barrier installed externally onto the outmost layer of a conventional display device such as a cathode ray tube (CRT) display, a liquid crystal display (LCD), a plasma display panel (PDP), a surface conduction electron-emitter display (SED), a field emission display (FED), a vacuum fluorescent display (VFD), an organic light-emitting diode (OLED) or an e-Paper, such that the overall thickness of the 3D video display device cannot be reduced effectively, and the light extraction efficiency may be lowered significantly.

### SUMMARY OF THE INVENTION

In view of the aforementioned shortcomings of the prior art, the inventor of the present invention based on years of experience in the related industry to conduct extensive researches and experiments, and finally developed a 3D video imaging device in accordance with the present invention to overcome the shortcomings of the prior art.

Therefore, it is a primary objective of the invention to overcome the aforementioned shortcomings and deficiencies of the prior art by providing a 3D video imaging device that can produce a sharp 3D image.

Another objective of the invention is to provide a 3D video imaging device that will not reduce the brightness of the 3D image.

Another objective of the invention is to provide a 3D video imaging device that can reduce the overall thickness of the 3D video imaging device.

Another objective of the invention is to provide a 3D video imaging device that can simplify the production process of the 3D video imaging device.

To achieve the foregoing objectives, the present invention provides a 3D video imaging device having a liquid crystal layer provided for displaying a multiple of images capable of producing a 3D image, a color filter plate attached onto the top of the liquid crystal layer by an optical adhesive material, a lens array installed onto a surface of the color filter plate, a plurality of light shielding elements installed onto a surface of the color filter plate or the lens array, and an optical sheet installed on the top of the lens array.

In the aforementioned structure, a combination of the liquid crystal layer, color filter plate and optical sheet is actually a basic structure of the conventional liquid crystal display panel. In the manufacturing process of present existing LCD panels, the lens array and the light shielding elements are installed in the LCD panels directly. Compared with the prior art, such arrangement can reduce the thickness of the overall structure and simplify the manufacturing process.

When the lens elements of the lens array are combined with the color filter plate, an optically clear adhesive (OCA) is attached onto the surface of the color filter plate, and the lens array is formed on a surface of the color filter plate directly by photo solidification.

In addition, the light shielding elements are selectively installed at positions on a surface of the color filter plate or a surface of the lens element, or directly formed in the color filter plate according to actual requirements and the light shielding elements are installed with an interval apart from each other and among the lens elements.

### BRIEF DESCRIPTION OF THE DRAWINGS

FIG. 1 is a side view of a first preferred embodiment of the present invention;

FIG. 2 is a perspective view of a portion of components in accordance with a first preferred embodiment of the present invention;

FIG. 3 is a partial side view of a first preferred embodiment of the present invention;

FIG. 4 is a side view of a second preferred embodiment of the present invention;

FIG. 5 is a side view of a third preferred embodiment of the present invention;

FIG. 6 is a side view of a fourth preferred embodiment of the present invention; and

FIG. 7 is a side view of a fifth preferred embodiment of the present invention.

### DETAILED DESCRIPTION OF THE PREFERRED EMBODIMENTS

The technical characteristics of the present invention will become apparent with the detailed description of preferred embodiments and the illustration of related drawings as follows.

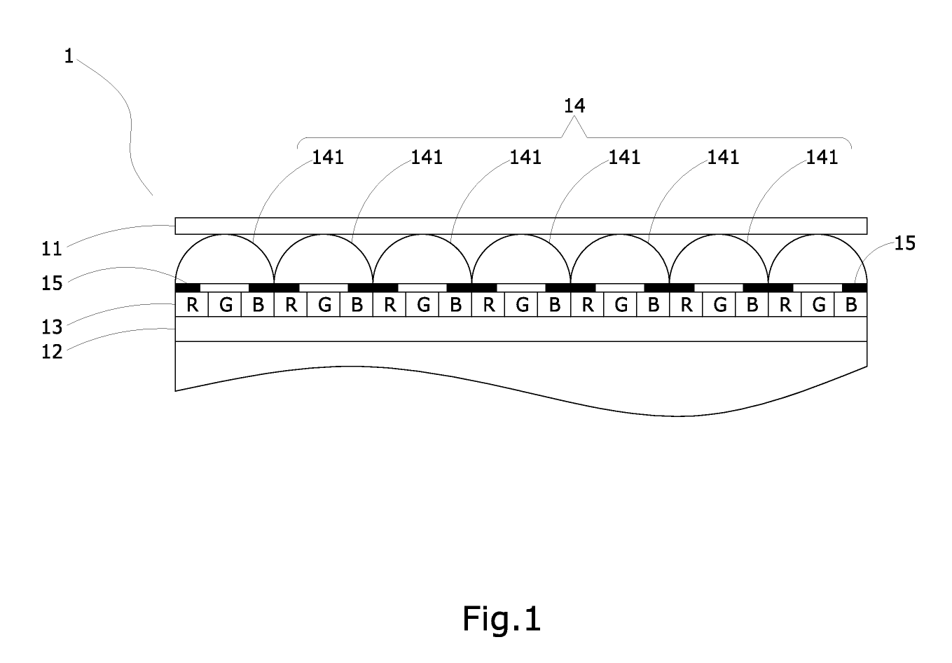

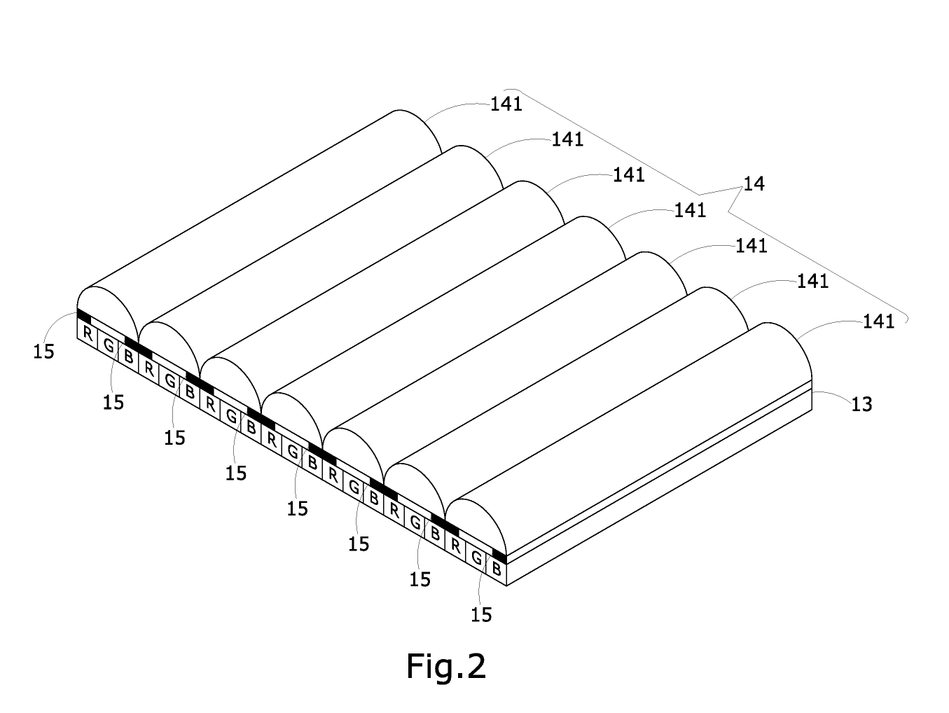

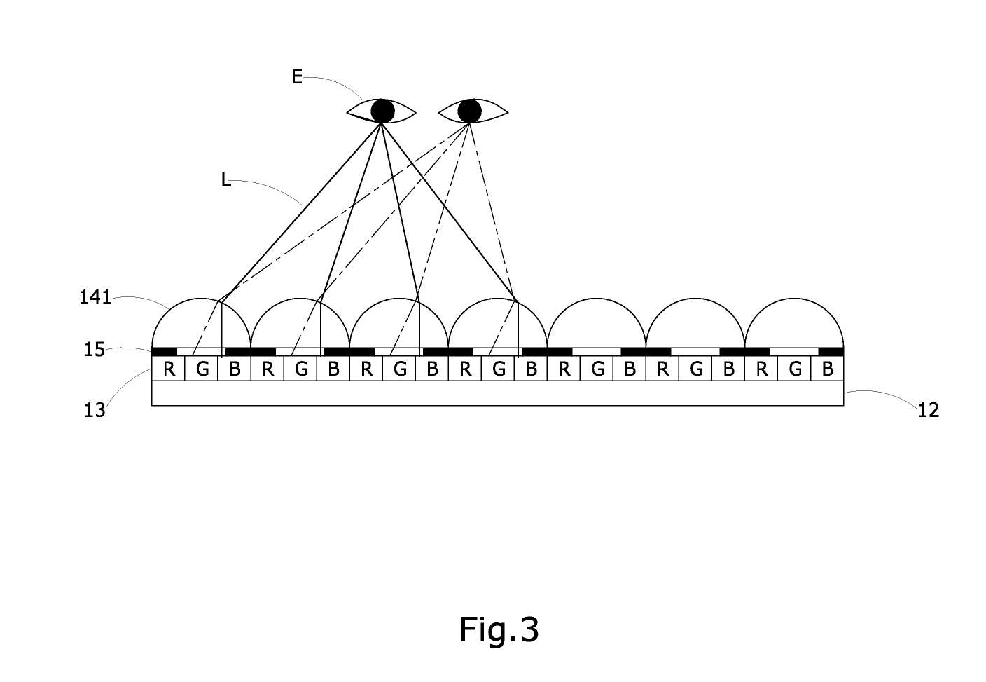

With reference to FIGS. 1 to 3 for a side view, a partial perspective view, and a partial side view of a 3D video imaging device in accordance with a first preferred embodiment of the present invention respectively, the 3D video imaging device comprises an optical sheet 11, a liquid crystal layer 12, a color filter plate 13, a lens array 14 and a plurality of light shielding elements 15.

The liquid crystal layer 12 is provided for displaying a plurality of images capable of producing a 3D image.

The color filter plate 13 is attached onto the top of the liquid crystal layer 12 by an optical adhesive material such as an optically clear adhesive (OCA).

The light shielding elements 15 are installed onto a surface of the color filter plate 13 by spluttering, screen printing, coating or adhesion. In this preferred embodiment, the light shielding elements 15 are installed at an upper surface of the color filter plate 13, but the light shielding elements 15 can also be installed at a lower surface of the color filter plate 13 during the manufacturing process.

The lens array 14 includes a plurality of lens elements 141 made of polyethylene terephthalate (PET), polycarbonate (PC), polyethylene (PE), polyvinyl chloride (PVC), polypropylene (PP), polystyrene (PS), polymethylmethacrylate (PMMA), or cycloolefin copolymer (COC). When the lens elements 141 of the lens array 14 are combined with the color filter plate 13, an optical adhesive material such as an optically clear adhesive (OCA) can be attached onto a surface of the color filter plate 13. In this preferred embodiment, the lens array 14 is attached onto a surface of the color filter plate 13 and covered onto the top of the light shielding elements 15, and the light shielding elements 15 are arranged with an interval apart from each other and corresponding to the lens elements 141. It is noteworthy to point out that the lens array 14 can be formed directly at an upper surface of the color filter plate 13, in addition to the aforementioned attaching method. Since the lens array 14 can be made of an optical material with a photo solidification property, therefore the optical material with the photo solidification property is coated onto a surface of the color filter plate 13 and covered onto the light shielding elements 15 after the light shielding elements 15 are installed onto the surface of the color filter plate 13, and the following methods can be selected for forming the lens array 14:

1. The optical material with the photo solidification property can be solidified directly by a light such as an ultraviolet light, and then cut into the lens elements 141 by a micro cutting tool.

2. The optical material with the photo solidification property can be solidified directly by a light such as an ultraviolet light, and then cut into the lens elements 141 by a laser cutting tool.

3. The optical material with the photo solidification property is processed by ultrasonic vibrations to form regular wavy lines on the surface of the optical material, and then solidified by a light such as an ultraviolet light to form the lens elements 141.

The aforementioned method are well-known art used for years and applied extensively in optical sheets such as prism sheets, and these are prior arts and will not be described further here. Any lens with a surface of a transparent optical sheet is covered within the scope of the present invention that has the lens array 14 formed on the surface of the color filter plate 13 directly.

The optical sheet 11 is attached to the top of the lens array 14 by an optical adhesive material, and the optical sheet 11 is a polarizer, a protective plate, a cover lens or a protective polarizer.

In the 3D video imaging principle of the present invention, the multiple of images processed by the liquid crystal layer 12 are refracted by the lens elements 141, such that the light sources of the images are projected towards predetermined directions and into left and right eyes of a viewer E respectively, such that the viewer's brain can combine the images to produce the effect of a 3D image. However, the lens may have a drawback of an optical structure, such as a poor refractive effect at an interval between the lenses or an edge of a single lens (which is at a position of a wave trough). As a result, the direction of the refracted light passing through the position of the wave trough cannot be controlled easily, and a stray light may be formed. To overcome the drawback of such optical structure, a light shielding element 15 is installed at an interval between lenses and provided for filtering the stray light to produce a clear image without any distortion and maintain a high brightness of the displayed 3D image.

In the structure of the present invention, a combination of the liquid crystal layer 12, color filter plate 13 and optical sheet 14 is actually a basic structure of the conventional liquid crystal display panel. Since the LCD panel is a well-known art and has been used for years, the LCD technology is a prior art and will not be described in details here. It is noteworthy to point out that the lens array 14 and the light shielding elements 15 of the present invention are installed in the LCD panel directly to achieve the effects of reducing the stack thickness and simplifying the manufacturing process, in addition to the effects of preventing the production of stray lights, enhancing the clarity of 3D images, and maintaining a high-brightness display effect.

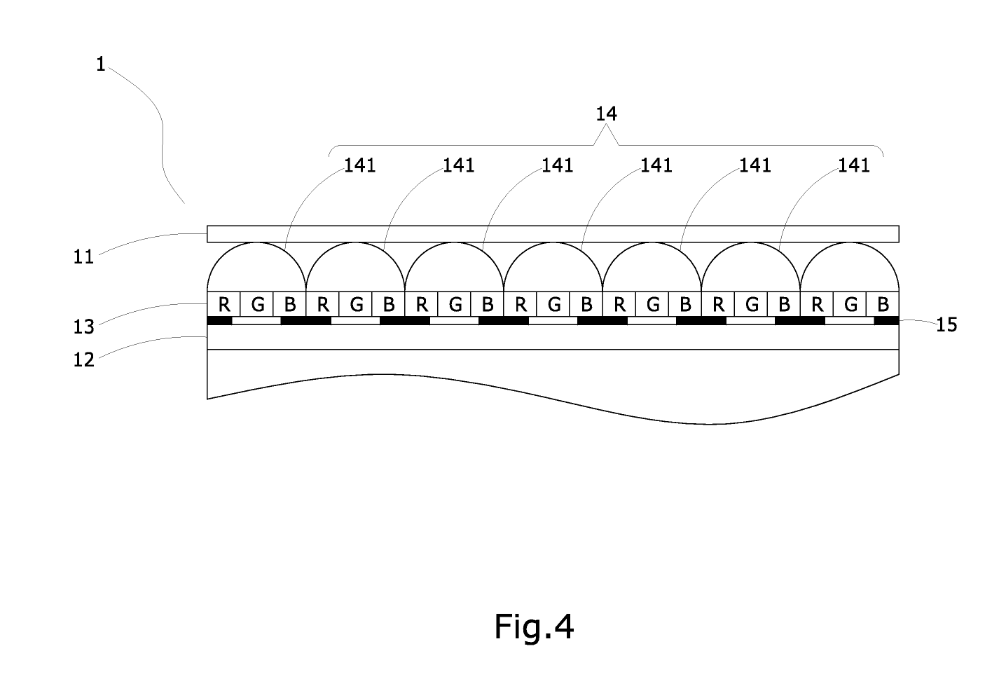

With reference to FIG. 4 for a side view of a second preferred embodiment of the present invention, the difference between this preferred embodiment and the first preferred embodiment resides on that the light shielding elements 15 are installed at a lower surface of the color filter plate 13, while the installation, properties and structure of other components are the same as the first preferred embodiment, and thus will not be described here again.

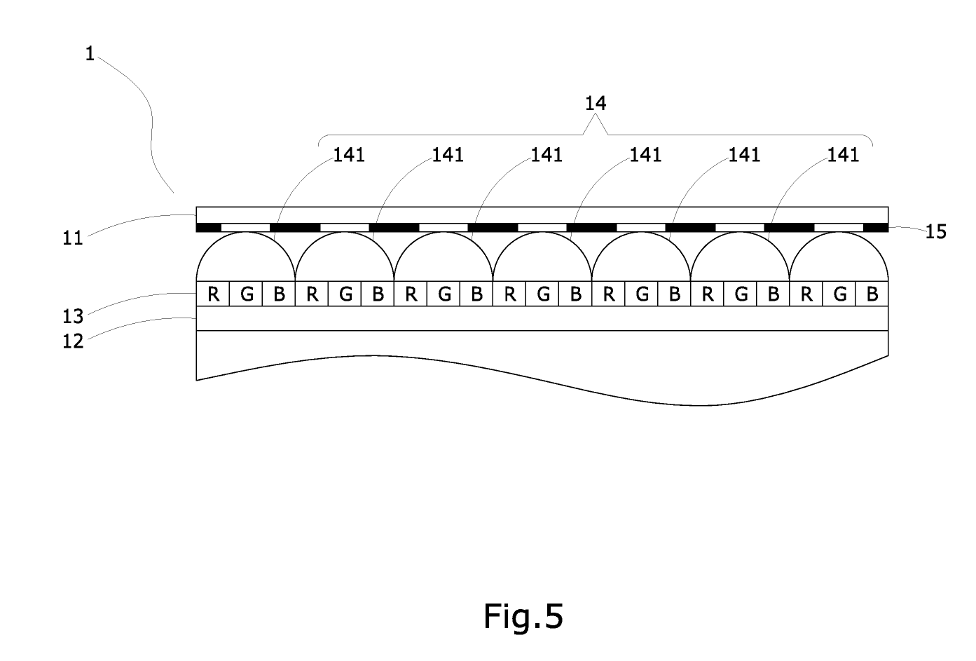

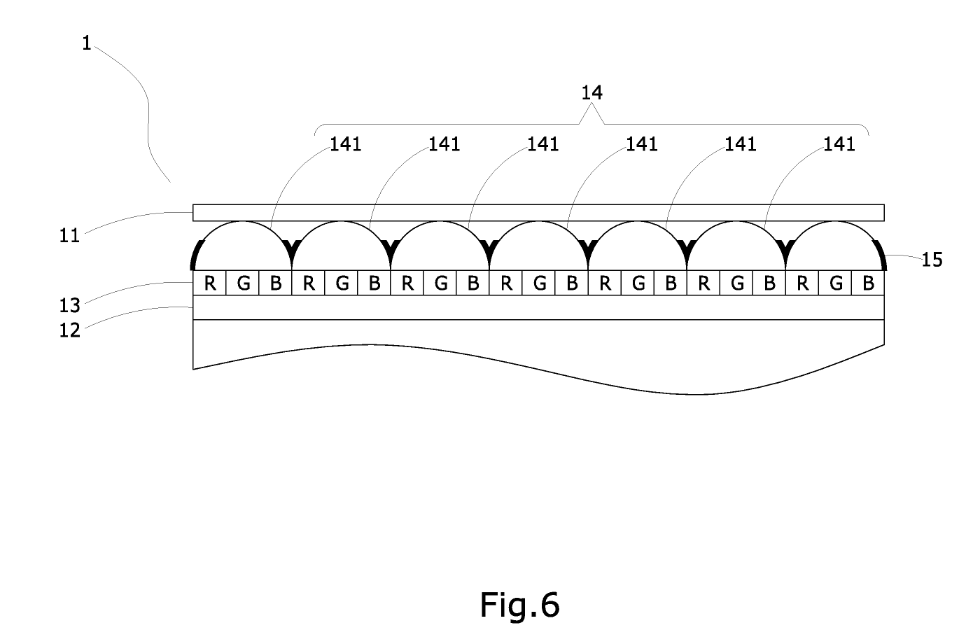

With reference to FIGS. 5 and 6 for side views of a third preferred embodiment and a fourth preferred embodiment of the present invention respectively, the difference between these preferred embodiments and the aforementioned preferred embodiments resides on that the light shielding elements 15 are installed on the lens elements 141 of the lens array 14, and can be installed directly onto a surface where adjacent lens elements 141 are connected, or installed directly at an upper plane of the lens elements 141. For example, the light shielding elements 15 are installed onto surfaces of wave troughs of the lens elements 141 as shown in FIG. 5. In other words, the lens elements 141 are installed at positions of wave troughs of adjacent lens elements 141. In FIG. 6, a plane is formed on the lens array 14 after the intervals among the lens elements 141 are filled with an optically clear adhesive (OCA), and the light shielding elements 15 are installed at positions of an upper surface of the lens elements 141 respectively, while the installation, properties and structure of other components are the same as the aforementioned preferred embodiments, and thus will not be described in details here again.

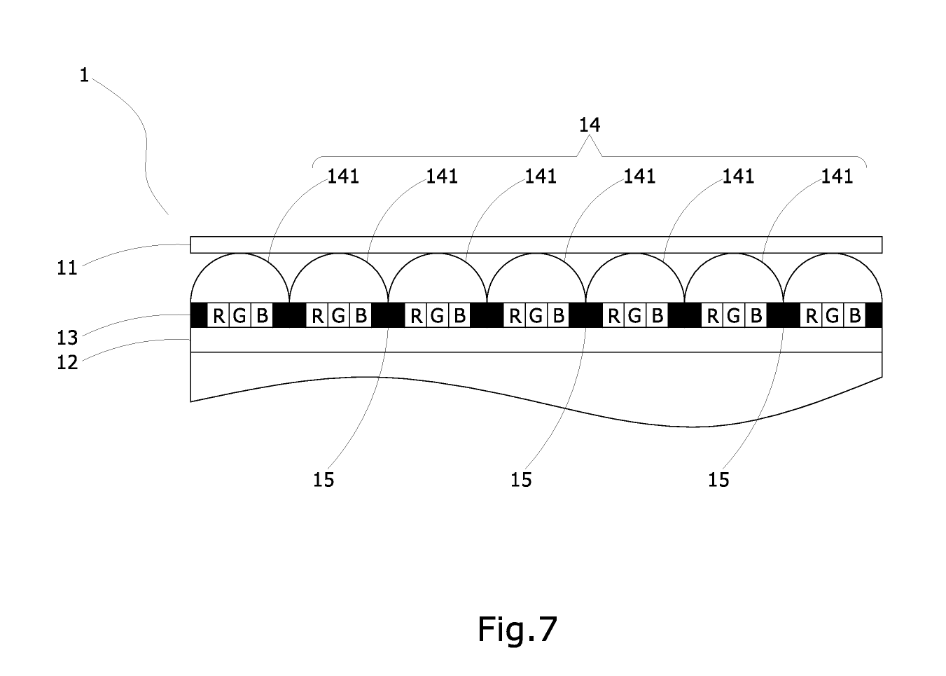

With reference to FIG. 7 for a side view of a fifth preferred embodiment of the present invention, the difference between this preferred embodiment and the aforementioned preferred embodiments resides on that the light shielding elements 15 are directly and integrally formed in the color filter plate 13. Since the color filter plate 13 includes three primary colors R, G, B in a cycle, therefore the light shielding elements 15 can be inserted into each cyclical arrangement directly to reduce the overall thickness. The installation, properties and structure of other components are the same as the aforementioned preferred embodiments, and thus will not be described here again.

It is noteworthy to point out that the lens elements 141 of the aforementioned preferred embodiments can be arranged continuously with a tilted angle, beside of their being arranged horizontally along an axial direction, and the embodiments include the light shielding elements 15 arranged with an interval apart from each other and corresponding to the lens elements 141 respectively and installed in a same tilted direction (not shown in the figure).

In summation of the description above, the invention improves over the prior art and complies with the patent application requirements, and thus is duly filed for patent application.

While the invention has been described by device of specific embodiments, numerous modifications and variations could be made thereto by those generally skilled in the art without departing from the scope and spirit of the invention set forth in the claims.

What is claimed is:

1. A three-dimensional (3D) video imaging device, comprising:
a liquid crystal layer, for displaying a multiple of images capable of producing a 3D image;
a color filter plate, installed at the top of the liquid crystal layer;
a lens array, installed at the top of the color filter plate, and having a plurality of lens elements; and
an optical sheet, installed at the top of the lens array.

2. The 3D video imaging device of claim 1, wherein the lens elements of the lens array are attached onto a surface of the color filter plate by an optically clear adhesive (OCA).

3. The 3D video imaging device of claim 1, wherein the lens elements of the lens array are formed at the top of the color filter plate directly.

4. The 3D video imaging device of claim 1, wherein the color filter plate includes a plurality of light shielding elements installed onto a surface of the color filter plate and at positions corresponding to the lens elements and arranged with an interval apart from each other.

5. The 3D video imaging device of claim 4, wherein the light shielding elements are installed onto a surface of the color filter plate by a method selected from the collection of spluttering, screen printing, coating and adhesion.

6. The 3D video imaging device of claim 4, wherein the lens elements of the lens array are installed at an upper surface of the color filter plate directly, and the light shielding elements are installed at a lower surface of the color filter plate.

7. The 3D video imaging device of claim 4, wherein the light shielding elements are installed at an upper surface of the color filter plate, and the lens elements of the lens array are covered onto the light shielding elements directly and formed at the top of the color filter plate.

8. The 3D video imaging device of claim 4, wherein the lens elements and the light shielding elements are installed in parallel with each other.

9. The 3D video imaging device of claim 4, wherein the lens elements and the light shielding elements are installed in a same tilted direction.

10. The 3D video imaging device of claim 1, further comprising a plurality of light shielding elements installed onto surfaces of the lens elements, and the light shielding elements are installed with an interval apart from each other and corresponding to the lens elements respectively.

11. The 3D video imaging device of claim 10, wherein the light shielding elements are installed onto the surface of the color filter plate by a method selected from the collection of spluttering, screen printing, coating and adhesion.

12. The 3D video imaging device of claim 11, wherein the lens elements of the lens array are formed at the top of the color filter plate directly, and the light shielding elements are installed at the intervals among the lens elements respectively.

13. The 3D video imaging device of claim 11, wherein the lens elements and the light shielding elements are installed in parallel with each other.

14. The 3D video imaging device of claim 11, wherein the lens elements and the light shielding elements are installed in a same tilted direction.

15. The 3D video imaging device of claim 1, further comprising a plurality of light shielding elements installed in the color filter plate, and the light shielding elements are installed with an interval apart from each other and corresponding to the lens elements respectively.

16. The 3D video imaging device of claim 15, wherein the lens elements and the light shielding elements are installed in parallel with each other.

17. The 3D video imaging device of claim 15, wherein the lens elements and the light shielding elements are installed in a same tilted direction.

18. The 3D video imaging device of claim 1, wherein the optical sheet is a polarizer, a protective plate, a cover lens, or a protective polarizer.

19. The 3D video imaging device of claim 1, wherein the lens elements are made of a material selected from the collection of polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

20. A three-dimensional (3D) video imaging device, comprising:
a liquid crystal layer, for displaying a multiple of images capable of producing a 3D image;
a color filter plate, installed at the top of the liquid crystal layer;
a lens array, installed at the top of the color filter plate, and having a plurality of lens elements;
a plurality of light shielding elements, installed onto a surface of the color filter plate, and the light shielding elements being installed with an interval apart from each other and corresponding to the lens elements; and
an optical sheet, installed at the top of the lens array.

21. The 3D video imaging device of claim 20, wherein the light shielding elements are installed onto the surface of the color filter plate by a method selected from the collection of spluttering, screen printing, coating and adhesion.

22. The 3D video imaging device of claim 20, wherein the lens elements of the lens array are attached onto a surface of the color filter plate by an optically clear adhesive (OCA).

23. The 3D video imaging device of claim 20, wherein the lens elements of the lens array are installed at an upper surface of the color filter plate directly, and the light shielding elements are installed at a lower surface of the color filter plate.

24. The 3D video imaging device of claim 20, wherein the light shielding elements are installed at an upper surface of the color filter plate, and the lens elements of the lens array are covered onto the light shielding elements directly and formed at the top of the color filter plate.

25. The 3D video imaging device of claim 20, wherein the lens elements and the light shielding elements are installed in parallel with each other.

26. The 3D video imaging device of claim 20, wherein the lens elements and the light shielding elements are installed in a same tilted direction.

27. The 3D video imaging device of claim 20, wherein the optical sheet is a polarizer, a protective plate, a cover lens, or a protective polarizer.

28. The 3D video imaging device of claim 20, wherein the lens elements are made of a material selected from the collection of polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

29. A three-dimensional (3D) video imaging device, comprising:
a liquid crystal layer, for displaying a multiple of images capable of producing a 3D image;
a color filter plate, installed at the top of the liquid crystal layer;
a lens array, installed at the top of the color filter plate, and having a plurality of lens elements;
a plurality of light shielding elements, installed onto a surface of the lens element, and the light shielding elements being installed with an interval apart from each other and corresponding to the lens elements; and
an optical sheet, installed at the top of the lens array.

30. The 3D video imaging device of claim 29, wherein the light shielding elements are installed onto a surface of the color filter plate by a method selected from the collection of spluttering, screen printing, coating and adhesion.

31. The 3D video imaging device of claim 29, wherein the lens elements of the lens array are attached onto a surface of the color filter plate by an optically clear adhesive (OCA).

32. The 3D video imaging device of claim 29, wherein the lens elements of the lens array are formed at the top of the color filter plate directly, and the light shielding elements are installed at intervals among the lens elements respectively.

33. The 3D video imaging device of claim 29, wherein the lens elements and the light shielding elements are installed in parallel with each other.

34. The 3D video imaging device of claim 29, wherein the lens elements and the light shielding elements are installed in a same tilted direction.

35. The 3D video imaging device of claim 29, wherein the optical sheet is a polarizer, a protective plate, a cover lens, or a protective polarizer.

36. The 3D video imaging device of claim 29, wherein the lens elements are made of a material selected from the collection of polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

37. A three-dimensional (3D) video imaging device, comprising:
a liquid crystal layer, for displaying a multiple of images capable of producing a 3D image;
a color filter plate, installed at the top of the liquid crystal layer, and having a plurality of light shielding elements installed therein and arranged with an interval apart from each other;
a lens array, installed at the top of the color filter plate, and having a plurality of lens elements arranged with an interval apart from each other and corresponding to the light shielding elements;
a plurality of light shielding elements, installed at positions corresponding to the lens elements and in the color filter plate; and
an optical sheet, installed at the top of the lens array.

38. The 3D video imaging device of claim 37, wherein the lens elements of the lens array is attached onto a surface of the color filter plate by an optically clear adhesive (OCA).

39. The 3D video imaging device of claim 37, wherein the lens elements of the lens array is formed at the top of the color filter plate directly.

40. The 3D video imaging device of claim 37, wherein the lens elements and the light shielding elements are installed in parallel with each other.

41. The 3D video imaging device of claim 37, wherein the lens elements and the light shielding elements are installed in a same tilted direction.

42. The 3D video imaging device of claim 37, wherein the optical sheet is a polarizer, a protective plate, a cover lens, or a protective polarizer.

43. The 3D video imaging device of claim 37, wherein the lens elements are made of a material selected from the collection of polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).
